(19) United States
(12) Patent Application Publication
(10) Pub. No.: US 2014/0260052 A1
(43) Pub. Date: Sep. 18, 2014

(54) COMPOSITE PANELS AND ASSEMBLIES

(71) Applicant: Hyundai Translead, San Diego, CA (US)

(72) Inventors: Christian S. Lee, San Diego, CA (US); Leszek S. Jaworski, San Diego, CA (US)

(21) Appl. No.: 13/801,614

(22) Filed: Mar. 13, 2013

(51) Int. Cl. B32B 3/06; E04C 2/00

(52) U.S. Cl. CPC B32B 3/06; E04C 2/00
USPC 52/578; 156/60; 428/77; 428/189

(57) ABSTRACT

A composite panel comprises a first outer layer, a second outer layer, a main panel section, and a mating section. The main panel section includes a main filler layer positioned between a main portion of the first outer layer and the second outer layer, and the main filler layer has a first mating edge. The mating section includes a lip formed of at least one of the first and second outer layers extending beyond the mating edge of the filler layer. Composite panel systems and methods of making composite roof panel assemblies are also provided.

### FIELD

The present disclosure relates to composite panels and to assemblies joining together one or more composite panels such as in cargo containers, truck trailers or building structures.

### BACKGROUND

Various composite panel constructions are known. In a typical composite panel, a sandwich construction is used that includes at least three layers. The three layers include first and second faces and sandwiched between them a middle layer also called a filler layer. Various filler layer materials or assemblies also are known. Examples of known filler layers include resins, plastics, honeycombs of various metals including plastics and metals, or non-honeycomb formed metals or plastics.

Various mechanisms and constructions are used to link together composite panels to form a longer wall or roof structure comprised of plural composite panels. Some such constructions for joining together composite panels utilize connectors that are fastened to adjoining panels, serving to connect the adjoining panels together serially. Among the deficiencies of some known joint constructions are relatively high cost, complex specially made components, and impairment of the filler layers leading to impairment of the structural integrity of the composite panel and the serially linked structure.

Among the uses of composite panels are for sidewalls or roofs of truck trailers and cargo containers. In such trailers or cargo containers multiple composite panels are joined in series, side-to-side or end-to-end to form longer constructions. In such constructions, the structural viability of the connection points, whether connected by joints or other mechanisms, are important given the potential for buckling of the elongated walls or roofs.

Accordingly there is a need for a composite wall connection mechanism that joins together one or more composite panels while retaining structural strength of the joined panels and eliminating the requirement for costly, specially made components. Likewise there is a need for an improved composite panel connection mechanism suitable for use in truck trailers and cargo containers.

### SUMMARY

The present disclosure, in its many embodiments, alleviates to a great extent the disadvantages of known composite panel constructions by providing composite panels with mating sections including lips which the filler layer is thinner or removed such that the panel mating sections are joined in proximity with one another. The mating sections of the composite panels mate with each other and mating edges of the panel mate with each other so a strong, easy joining of panels is accomplished without joints or other extra connector components.

In exemplary embodiments, a composite panel comprises a first outer layer, a second outer layer, a main panel section, and a mating section. The main filler layer is positioned between a main portion of the first outer layer and the second outer layer, and the main filler layer having a first mating edge. The mating section includes a lip formed of at least one of the first and second outer layers extending beyond the mating edge of the filler layer. At least one of the first and second outer layers may further comprise a paint finish.

Exemplary embodiments of a composite panel may further comprise a transition section between the main panel section and the mating section in which either the first or second outer layers has an angle so as to transition into closer proximity with the other outer layer. The angle may be a right angle or an obtuse angle. In exemplary embodiments, the lip comprises a mating filler layer positioned between a mating portion of the first outer layer and the second outer layer, with the mating filler layer being thinner than the main filler layer. In other embodiments, the lip may comprise one of the first and second outer layers, the lip lacking a filler layer.

Exemplary embodiments include a composite wall panel assembly including first and second composite panels, or a series of composite panels arranged with respect to one another. In an exemplary wall panel embodiment, a first composite panel has a first outer layer, a second outer layer, a main panel section, and a mating section. The main panel section includes a main filler layer positioned between a main portion of the first outer layer and the second outer layer. The main filler layer has a first mating edge and a second mating edge opposite the first mating edge. The mating section may include a lip extending beyond the mating edge of the filler layer.

A second composite panel has a first outer layer, a second outer layer, a main panel section, and a mating section. The main panel section includes a main filler layer positioned between a main portion of the first outer layer and the second outer layer. The main filler layer has a first mating edge and a second mating edge opposite the first mating edge. The mating section may include a lip extending beyond the mating edge of the filler layer. In exemplary embodiments, the first composite panel is adjacent to the second composite panel such that the mating section of the first composite panel mates with the mating section of the second composite panel and the first mating edge of the first panel mates with the second mating edge of the second panel.

Another exemplary embodiment includes a roof panel assembly including at least first and second composite panels or a series of composite panels arranged with respect to one another. In such an arrangement, roof panels are arranged adjacent one another via overlapping mating sections, such as including a lip extending beyond a mating edge of the filler layers of the adjacent panels. In exemplary embodiments, the lip of the first composite panel comprises one of the first and second outer layers without a filler layer and mates with a portion of the main filler layer of the second composite panel. In other exemplary embodiments, the lip of the second composite panel comprises one of the first and second outer layers without a filler layer and mates with a portion of the main filler layer of the first composite panel. The composite panel assembly may further comprise an adhesive layer between the lip of the first composite panel and the main filler layer of the second composite panel. The lip of the first composite panel and the second composite panel may comprise a mating filler layer positioned between a mating portion of the first outer layer and the second outer layer, with the mating filler layer being thinner than the main filler layer. In exemplary embodiments, the lip of the of the first composite panel mates with the lip of the second composite panel, and the assembly may further comprise an adhesive layer between the lip of the first composite panel and the lip of the second composite panel.

Exemplary embodiments also include methods of making a composite panel assembly comprising providing a first composite panel and a second composite panel and forming a composite panel assembly by placing the first composite panel adjacent to the second composite panel. The first composite panel has a first outer layer, a second outer layer, a main panel section, and a mating section. The main panel section includes a main filler layer positioned between a main portion of the first outer layer and the second outer layer. The main filler layer has a first mating edge and a second mating edge opposite the first mating edge. The mating section may include a lip extending beyond the mating edge of the filler layer.

The second composite panel provided in exemplary methods has a first outer layer, a second outer layer, a main panel section, and a mating section. The main panel section includes a main filler layer positioned between a main portion of the first outer layer and the second outer layer. The main filler layer has a first mating edge and a second mating edge opposite the first mating edge. The mating section may include a lip extending beyond the mating edge of the filler layer.

Exemplary methods include the step of forming a composite panel assembly by placing the first composite panel adjacent to the second composite panel such that the mating section of the first composite panel mates with the mating section of the second composite panel and the first mating edge of the first panel mates with the second mating edge of the second panel. Exemplary methods may further comprise mating the lip of the first composite panel with a portion of the main filler layer of the second composite panel. An adhesive layer may also be inserted between the lip of the first composite panel and the main filler layer of the second composite panel. In exemplary embodiments, the lip of the of the first composite panel is mated with the lip of the second composite panel, and an adhesive layer may be inserted between the lip of the first composite panel and the lip of the second composite panel. Exemplary embodiments may further comprise providing a transition section between the main panel section and the mating section in which either the first or second outer layers has an angle so as to transition into closer proximity with the other outer layer.

In some embodiments, the panel assemblies are included in wall assemblies buildings, or transport containers such as cargo containers or truck trailers. In other embodiments, the panel assemblies are included in roof assemblies of buildings, transport containers, cargo containers or truck trailers.

Accordingly, it is seen that a composite panel joint construction is provided that provides for the structural integrity of individual panels while providing a joining section. These and other features and advantages will be appreciated from review of the following detailed description, along with the accompanying figures in which like reference numbers refer to like parts throughout.

### BRIEF DESCRIPTION OF THE DRAWINGS

The foregoing and other objects of the disclosure will be apparent upon consideration of the following detailed description, taken in conjunction with the accompanying drawings, in which:

FIG. 1A is a cross-sectional view of embodiments of composite panels in accordance with the present disclosure;

FIG. 1B is a top view of embodiments of composite panels in accordance with the present disclosure;

FIG. 1C is a cross-sectional view of embodiments of composite panels in accordance with the present disclosure;

FIG. 2 is a perspective view of an embodiment of a composite panel in accordance with the present disclosure;

FIG. 3 is a side view of an embodiment of a composite panel in accordance with the present disclosure;

FIG. 4 is a bottom perspective view of an embodiment of a composite panel in accordance with the present disclosure;

FIG. 5A is a cross-sectional view of embodiments of composite panels in accordance with the present disclosure;

FIG. 5B is a top view of embodiments of composite panels in accordance with the present disclosure;

FIG. 6 is a perspective view of embodiments of two composite panels in accordance with the present disclosure;

FIG. 7 is a side view of embodiments of two composite panels in accordance with the present disclosure;

FIG. 8 is a perspective view of embodiments of two composite panels being connected in accordance with the present disclosure;

FIG. 9 is a side view of embodiments of two composite panels being connected in accordance with the present disclosure;

FIG. 10A is a top view of a composite roof assembly in accordance with the present disclosure;

FIG. 10B is a side view of a composite roof assembly in accordance with the present disclosure;

FIG. 10C is a cross-sectional view of a composite roof assembly in accordance with the present disclosure;

FIG. 10D is a cross-section view of a composite roof assembly in accordance with the present disclosure; and

FIG. 10E is a perspective view of a portion of a composite roof assembly in accordance with the present disclosure.

### DETAILED DESCRIPTION

In the following paragraphs, embodiments will be described in detail by way of example with reference to the accompanying drawings, which are not drawn to scale, and the illustrated components are not necessarily drawn proportionately to one another. Throughout this description, the embodiments and examples shown should be considered as exemplars, rather than as limitations of the present disclosure. As used herein, the “present disclosure” refers to any one of the embodiments described herein, and any equivalents. Furthermore, reference to various aspects of the disclosure throughout this document does not mean that all claimed embodiments or methods must include the referenced aspects.

Referring to FIG. 1A through FIG. 4, exemplary embodiments of composite panels 10 in a composite panel assembly 1 comprise one or more outer layers and one or more filler layers. The illustrated composite panel has three layers. A first outer layer 12 and a second outer layer 14 are provided, and these layers also may be referred to as face or skin layers. It should be appreciated that in some applications, the respective outer layers 12 and 14 may be top and bottom layers, or also inside and outside layers. For example in a truck trailer, it may be desired that the flatter layer 14 be positioned on an inside surface of the trailer and the other layer 12 be on the outside surface of the trailer. An inner layer, also called the main filler layer 16, is positioned between a main portion 18 of the first outer layer 12 and a main portion 20 of the second outer layer 14.

In exemplary embodiments, composite panel 10 has at least two sections. A main panel section 22 is a portion of the panel in which the main filler layer 16 is positioned between the inner and outer layers 14. More particularly, in the main panel section 22 the main filler layer 16 is positioned between the main portion 18 of the first outer layer 12 and the main portion 20 of the second outer layer 14. An optional resin, or finish, layer 13 and a seam cover 15 may be provided to cover the connection points between panels. The seam cover 15 optionally may be a roof seam cover or wall seam cover. Likewise a reinforcing rib or logistic slots may be positioned in one or more seams. As shown, in FIG. 1C, exemplary embodiments may optionally include a paint and/or laminate finish 31 on top of a substantial portion of first and second outside layers 12 and 14. The paint finish 31 optionally may terminate at lip receiving surface 29 or may extend over lip receiving surface 29.

Composite panel 10 may also have at least one mating section 24 (also numbered 24a and 24b) configured to provide a mating connection with another composite panel. The mating section or sections 24 may include a lip 26, which, in exemplary embodiments, is formed of one of the outer layers 12, 14. The composite panels 10 may be structured as edge panels 10a and 10e with only one mating section 24 to connect with one other composite panel 10 or as intermediate composite panels 10b, 10c, and 10d with two mating sections 24a, 24b on opposite ends of the panel so they can mate with two other composite panels, one at each end.

FIGS. 2-4 depict exemplary mating sections 24 of composite panel 10 in more detail. As seen in FIG. 2 the first mating section 24a comprises the first outer layer 12 extending beyond a first mating edge 28a of the main filler layer 16. The portion of the first outer layer 12 that extends past the mating edge 28 of the main filler layer 16 forms a lip 26 that mates with a portion of the main filler layer 16 of a first adjacent panel. Referring to FIGS. 3 and 4, a second mating section 24b can be seen in which the second outer layer 14 extends beyond a second mating edge 28b of the main filler layer 16. The portion of the second outer layer 14 forms a lip 26 that will mate with a portion of the main filler layer 16 of a second adjacent panel at the opposite end of the first adjacent panel.

Composite panel 10 optionally may include a transition section 34 between the main panel section 22 and the mating section 24. In exemplary embodiments, the transition section is comprised of the mating edge 28 and the point at which the first or second outer layer 12, 14 begins to extend beyond the main filler layer 16.

In FIG. 4, it can be seen that an end portion of the first outer layer 12 adjacent the second mating edge 28b may form a lip receiving surface 29 that can mate with a lip of the second adjacent panel. An adhesive layer 32 may be provided to securely connect the mating sections 24 of adjacent panels. More particularly, the adhesive layer 32 could be located between the lips 30 and corresponding portions of main filler layers 16 that mate to connect adjacent panels, as shown in FIG. 1A. In exemplary embodiments, the adhesive layer 32 may comprise two or more adhesive strips 32a, 32b. Each adhesive strip 32a, 32b would be used to connect an underside of a lip 26 of one panel 10 to a lip receiving surface 29 of an adjacent panel. It should be noted that any known connecting or fastening devices could be used instead of or in addition to adhesives, including but not limited to, mechanical fasteners such as screws or bolts. An arrangement of several adjacent composite panels 10a-10e together in a composite panel assembly 1 can also be seen in FIGS. 1A and 1B.

Turning to FIGS. 5A-5B, exemplary embodiments of composite panels 110 in a composite panel or roof assembly 101 include a first outer layer 12 and a second outer layer 14. A main filler layer 16 is positioned between a main portion 18 of the first outer layer 12 and a main portion 20 of the second outer layer 14. In exemplary embodiments, the main filler layer 16 is positioned between the inner and outer layers 14 and forms the main panel section 22. More particularly, in the main panel section 22 the main filler layer 16 is positioned between the main portion 18 of the first outer layer 12 and the main portion 20 of the second outer layer 14.

Exemplary composite panels 10 have at least one mating section 24 and at least one transition section 34 between the main panel section 22 and the mating section 24. In the embodiment illustrated in FIGS. 5A and 5B, the transition section 34 is at an angle other than perpendicular to outer layer 12. The first mating section 24a is comprised of a portion of the first outer layer 12 extending beyond a first mating edge 28a of the main filler layer 16 such that the extending portion of the first outer layer 12 forms a lip 26. As discussed in more detail herein, the lip 26 that mates with a portion of the main filler layer 16 of a first adjacent panel.

As best seen in FIG. 5A, an exemplary transition section 34 is a region in which one or both of the outer layers 12, 14 are shaped, such as angled, in order to bring them into relatively closer proximity with one another. More particularly, a composite panel 10b for an intermediate position in the panel assembly or roof assembly 101 has a first and second transition sections 34a, 34b, in each of which the first outer layer 12 has an angle 13a, 13b at each end while the second outer layer 14 is not angled so as to maintain a flat profile. Intermediate composite panel 10c, intended to mate with panel 10b, also has a first and second transition sections 34a, 34 wherein the second outer layer 12 has sloped portions 13a, 113b at each end while the first outer layer has no angle and maintains a relatively flat profile. In such exemplary embodiments, the angled portion of the transition section serves as the mating edge of the panel.

In the transition sections 34a, 34b and mating sections 24a, 24b, a transitional filler layer 40 is optionally included. In some exemplary embodiments, such as those discussed above in connection with FIGS. 1A-4, there is no filler layer in the transition section or the mating section. In other exemplary embodiments, the transitional filler layer extends through the transition section into only a portion of the mating section. As best seen in FIG. 5A, in exemplary embodiments, the transitional filler layer 40 extends through the transition section 34 and through the entire or substantially the entire portion of the mating section 24 including the lip 26.

Referring again to FIG. 5A, each mating section 24 includes a transitional filler layer 40 positioned between the outer layers 12, 14. The transitional filler layer 40 extends from the transition section 34 to the end of the mating section 24. As mentioned above, the transition section 34 may have any angle so long as an adjacent composite panel 10 has a corresponding angle in its transition section so the two transitions sections can mate and the panels can be joined. In exemplary embodiments, they optionally are joined by a layer of adhesive 32. In the exemplary embodiment depicted in FIG. 5A, first outer layer 12 of the transition section 34b of composite panel 10b is angled (or curved) to be positioned in to proximity with the second outer layer 14 of the transition section 34a of panel 10c.

It should be understood that intermediate composite panels could be configured such that a first transition section 34a has an angled first outer layer 12 and a flat second outer layer 14 while a second opposite transition section 34b has an angled second outer layer 14 and flat first outer layer 12. Composite panels 10a, 10d positioned at the front or back end of the roof assembly 101 have only one transition section 34 where they connect with an intermediate composite panel. In exemplary embodiments, the other ends of each front or back composite panel 10a, 10d are substantially flat.

Exemplary composite panels for intermediate locations in the composite panel assembly 101 may have a second mating section 24b in which the second outer layer 14 extends beyond a second mating edge 28b of the main filler layer 16. The portion of the second mating edge 28b forms a lip 26 that will mate with a portion of the main filler layer 16 of a second adjacent panel at the opposite end of the first adjacent panel.

In operation, at least a first and second composite panel 10b, 10c are provided in which a main filler layer 16 is located between a main portion 18 of the first outer layer 12 and a main portion 20 of the second outer layer 14. The main filler layer 16 has a first mating edge 28a and second mating edge 28b, and each composite panel 10b, 10c also comprises at least one mating section 24 including a lip 26 extending beyond the mating edge 28 of the main filler layer 16.

With reference to FIGS. 6-9, exemplary methods of making a composite roof panel assembly 1 include placing the first composite panel 10b adjacent the second composite panel 10c such that the complementary mating sections 24a, 24b of each panel are in a position to mate. More particularly, the first mating section 24a of composite panel 10b is positioned so it is aligned with the second mating section 24b of composite panel 10c. As best seen in FIGS. 8 and 9, this positioning step places the lip 26 of the first mating section 24a of composite panel 10b so it can be laid flat on the lip receiving surface 29 of the first outer layer 12 of panel 10c.

In complementary fashion, the lip 26 of the second mating section 24b of composite panel 10c is laid flat on the lip receiving surface 29 of the second outer layer 14 of panel 10b. As shown in FIG. 9, the mating edges of the adjacent panels are aligned such that the first mating edge 28a of the composite panel 10b mates with the second mating edge 28b of the adjacent composite panel 10c. An adhesive layer 32 may be inserted to securely connect the mating sections 24 of adjacent panels. More particularly, the adhesive layer 32 could be located between the lips 30 and corresponding receiving surfaces 29 of the first and second outer layers 12, 14 that mate to connect adjacent panels, as shown in FIG. 1A. An optional resin, paint, or other finish layer 13 and a roof seam cover 15 may be placed on top of the connections points between panels.

In exemplary embodiments such as those discussed in connection with FIGS. 5A and 5B, methods of making a composite wall or roof panel assembly 101 would contain desired variations upon the above-described method steps such as due to the differences in the mating sections of the different embodiments. More particularly, the composite panels 10 provided to assemble assembly 101 have mating sections 24 in which one or both of the outer layers 12, 14 are shaped or angled, as discussed in more detail above. Also, a transitional filler layer 40 is provided that extends through the transition section 34 and through the entire or substantially the entire portion of the mating section 24.

Accordingly, the first mating section 24a of a first composite panel 10b is positioned adjacent to the second mating section 24b of a second composite panel 10c. More particularly, the two composite panels 10b, 10c are aligned such that angle 13a of the first transition section 34a of panel 10b mates with angle 13b of the second transition section 34b of panel 10c. The second, unangled or flat, outer layers 14 of each panel 10a, 10b are also thereby aligned angled so as to maintain a flat profile across the joined panels and the entire composite roof panel assembly.

Turning to FIGS. 10A-10E, optionally one or more roof assembly components maybe be utilized to join a composite panel roof assembly 1 to a truck trailer or cargo container. In one example, a truck trailer or cargo container is provided in which a composite roof panel assembly 1 is joined to a truck trailer side wall using capping strips 52, trusses 54, and other support and connection components. More particularly, the composite panels 10 are held securely in place roof capping strips 52. In exemplary embodiments, several capping strips, including a main roof capping strip 52a, a front roof capping strip 52b, a rear roof capping strip 52c, and a radial roof capping strip 52d, are used in concert to secure the roof assembly to a trailer or container. Fasteners such as screw trusses 54a, 54b may be used to maintain the connection between the capping strips 52 and the composite panels 10. Exemplary embodiments may include foam tape 56, or other adhesives, as well as sealants 58 disposed around the roof assembly 1. A front and rear roof filler 60a, 60b may be provided and may be connected to a roof edge angle component 62 via a fastener such as a wood screw pan head 64. It should be appreciated that other connector and support components and mechanisms also may be used in any combination so long as a sufficient connection and support is provided to securely maintain the roof assembly 1 to the truck trailer or cargo container.

Thus, it is seen that a composite panels and assemblies are provided. It should be understood that any of the foregoing configurations and specialized components or may be interchangeably used with any of the apparatus or assembly of the preceding embodiments. Although illustrative embodiments are described hereinabove, it will be evident to one skilled in the art that various changes and modifications may be made therein without departing from the scope of the disclosure. It is intended in the appended claims to cover all such changes and modifications that fall within the true spirit and scope of the disclosure.

What is claimed is:

1. A composite panel comprising:
a first outer layer;
a second outer layer;
a main panel section including a main filler layer positioned between a main portion of the first outer layer and the second outer layer, the main filler layer having a first mating edge; and
a mating section including a lip formed of at least one of the first and second outer layers extending beyond the mating edge of the filler layer.

2. The composite panel of claim 1 further comprising a transition section between the main panel section and the mating section in which either the first or second outer layers has an angle so as to transition into closer proximity with the other outer layer.

3. The composite panel of claim 1 wherein the lip comprises a mating filler layer positioned between a mating portion of the first outer layer and the second outer layer, the mating filler layer being thinner than the main filler layer.

4. The composite panel of claim 2 wherein the lip comprises one of the first and second outer layers, the lip lacking a filler layer.

5. The composite panel of claim 2 wherein the angle is a right angle.

6. The composite panel of claim 2 wherein the angle is an obtuse angle.

7. The composite panel of claim 1 wherein at least one of the first and second outer layers further comprises a paint finish.

8. A composite wall panel assembly, comprising:
a first composite wall panel having:
a first outer layer;
a second outer layer;
a main panel section including a main filler layer positioned between a main portion of the first outer layer and the second outer layer, the main filler layer having a first mating edge and a second mating edge opposite the first mating edge; and
a mating section including a lip extending beyond the mating edge of the filler layer;
a second composite wall panel having:
a first outer layer;
a second outer layer;
a main panel section including a main filler layer positioned between a main portion of the first outer layer and the second outer layer, the main filler layer having a first mating edge and a second mating edge opposite the first mating edge; and
a mating section including a lip extending beyond the mating edge of the filler layer;
wherein the first composite panel is adjacent to the second composite panel such that the mating section of the first composite panel mates with the mating section of the second composite panel and the first mating edge of the first panel mates with the second mating edge of the second panel.

9. The composite wall panel assembly of claim 8 wherein the lip of the first composite panel comprises one of the first and second outer layers without a filler layer and mates with a portion of the main filler layer of the second composite panel.

10. The composite wall panel assembly of claim 8 wherein the lip of the second composite panel comprises one of the first and second outer layers without a filler layer and mates with a portion of the main filler layer of the first composite panel.

11. The composite wall panel assembly of claim 9 further comprising an adhesive layer between the lip of the first composite panel and the main filler layer of the second composite panel.

12. The composite wall panel assembly of claim 8 wherein the lip of the first composite panel and the second composite panel comprises a mating filler layer positioned between a mating portion of the first outer layer and the second outer layer, the mating filler layer being thinner than the main filler layer.

13. The composite wall panel assembly of claim 12 wherein the lip of the of the first composite panel mates with the lip of the second composite panel.

14. The composite wall panel assembly of claim 13 further comprising an adhesive layer between the lip of the first composite panel and the lip of the second composite panel.

15. The composite wall panel assembly of claim 8 further including a logistic slot member positioned between the first and second wall panels.

16. A composite roof panel assembly, comprising:
a first composite roof panel having:
a first outer layer;
a second outer layer;
a main panel section including a main filler layer positioned between a main portion of the first outer layer and the second outer layer, the main filler layer having a first mating edge and a second mating edge opposite the first mating edge; and
a mating section including a lip extending beyond the mating edge of the filler layer;
a second composite roof panel having:
a first outer layer;
a second outer layer;
a main panel section including a main filler layer positioned between a main portion of the first outer layer and the second outer layer, the main filler layer having a first mating edge and a second mating edge opposite the first mating edge; and
a mating section including a lip extending beyond the mating edge of the filler layer;
wherein the first composite panel is adjacent to the second composite panel such that the mating section of the first composite panel mates with the mating section of the second composite panel and the first mating edge of the first panel mates with the second mating edge of the second panel.

17. The composite roof panel assembly of claim 16 wherein the lip of the first composite panel comprises one of the first and second outer layers without a filler layer and mates with a portion of the main filler layer of the second composite panel.

18. The composite roof panel assembly of claim 16 wherein the lip of the second composite panel comprises one of the first and second outer layers without a filler layer and mates with a portion of the main filler layer of the first composite panel.

19. The composite roof panel assembly of claim 17 further comprising an adhesive layer between the lip of the first composite panel and the main filler layer of the second composite panel.

20. A method of making a composite roof panel assembly, comprising:
providing a first composite panel having:
a first outer layer;
a second outer layer;
a main panel section including a main filler layer positioned between a main portion of the first outer layer and the second outer layer, the main filler layer having a first mating edge and a second mating edge opposite the first mating edge; and
a mating section including a lip extending beyond the mating edge of the filler layer;
providing a second composite panel having:
a first outer layer;
a second outer layer;
a main panel section including a main filler layer positioned between a main portion of the first outer layer and the second outer layer, the main filler layer having a first mating edge and a second mating edge opposite the first mating edge; and
a mating section including a lip extending beyond the mating edge of the filler layer;
forming a composite roof panel assembly by placing the first composite panel adjacent to the second composite panel such that the mating section of the first composite panel mates with the mating section of the second composite panel and the first mating edge of the first panel mates with the second mating edge of the second panel.

21. The method of claim 20 further comprising mating the lip of the first composite panel with a portion of the main filler layer of the second composite panel.

22. The method of claim 22 further comprising inserting an adhesive layer between the lip of the first composite panel and the main filler layer of the second composite panel.

23. The method of claim 20 further comprising mating the lip of the of the first composite panel with the lip of the second composite panel.

24. The method of claim 23 further comprising inserting an adhesive layer between the lip of the first composite panel and the lip of the second composite panel.

25. The method of claim 20 further comprising providing a transition section between the main panel section and the mating section in which either the first or second outer layers has an angle so as to transition into closer proximity with the other outer layer.
